(19) United States
(12) Patent Application Publication
(10) Pub. No.: US 2026/0219853 A1
(43) Pub. Date: Jul. 30, 2026

(54) AI-ENHANCED FIRMWARE DEVELOPMENT AND MANAGEMENT PLATFORM WITH PLUGIN INTEGRATION CAPABILITIES

(71) Applicant: American Megatrends International, LLC, Duluth, GA (US)

(72) Inventors: Manoj Kumar P, Panruti (IN); Sriram Santhanam, Chennai (IN); Hari Venkatachalam, Bengaluru (IN)

(21) Appl. No.: 19/041,621

(22) Filed: Jan. 30, 2025

(51) Int. Cl. G06F 8/60; G06F 8/35; G06F 11/3604

(52) U.S. Cl. CPC G06F 8/60; G06F 8/35; G06F 11/3604

(57) ABSTRACT

One or more computing devices receives plugin configuration data through a plugin creation interface. The one or more computing devices creates a plugin based on the plugin configuration data. The plugin serves as an interface between a user and an artificial intelligence model. The one or more computing devices initiates a model training process based on the model type selection. The model training process uses a specific application programming interface (API) endpoint to train the artificial intelligence model. The one or more computing devices stores a trained model output upon completion of the model training process. The one or more computing devices tags the trained model output with the plugin name and an API endpoint. The one or more computing devices validates functionality of the plugin using the trained model output via the API endpoint. The one or more computing devices deploys the plugin to a plugin marketplace upon validation.

### BACKGROUND

### Field

The present disclosure relates generally to computer systems, and more particularly, to techniques of creating and utilizing artificial intelligence (AI) plugins for automating firmware development tasks, where the plugins serve as intermediaries between user requests and AI models.

### Background

The statements in this section merely provide background information related to the present disclosure and may not constitute prior art.

Firmware development has become increasingly complex due to the growing diversity of hardware platforms and the need to support various configurations. Firmware development processes often involve manual steps that are time-consuming and error-prone, particularly when porting firmware from evaluation boards to customer reference boards or production platforms. Engineers typically need to manually modify device tree source (DTS) files, debug boot logs, and configure hardware settings based on platform-specific requirements. This manual intervention not only extends development cycles but also requires significant expertise and resources.

The emergence of artificial intelligence (AI) and machine learning (ML) technologies has created opportunities to automate various software development tasks. In particular, large language models (LLMs) have demonstrated capabilities in code generation, debugging, and documentation. However, these general-purpose AI models are not specifically tailored for firmware development tasks, which often require specialized knowledge of hardware configurations, platform specifications, and low-level system operations. Additionally, while various AI-powered development tools exist, they typically focus on high-level software development rather than firmware-specific challenges.

Firmware development teams faces challenges in effectively using AI technologies across different departments and use cases. There was no unified platform that could integrate diverse AI models and handle various firmware development scenarios, from DTS file modifications to hardware setup verification. Furthermore, existing solutions lacked the flexibility to accommodate both text-based processing (such as analyzing boot logs) and image-based analysis (such as evaluating board setups).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a system are provided. The apparatus may include one or more computing devices. The one or more computing devices receives plugin configuration data through a plugin creation interface. The plugin configuration data includes a plugin name, a plugin description, and a model type selection. The one or more computing devices creates a plugin based on the plugin configuration data. The plugin serves as an interface between a user and an artificial intelligence model. The one or more computing devices initiates a model training process based on the model type selection. The model training process uses a specific application programming interface (API) endpoint to train the artificial intelligence model. The one or more computing devices stores a trained model output upon completion of the model training process. The one or more computing devices tags the trained model output with the plugin name and an API endpoint. The one or more computing devices validates functionality of the plugin using the trained model output via the API endpoint. The one or more computing devices deploys the plugin to a plugin marketplace upon validation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system that includes a baseboard management controller and a host computer.

FIG. 2 is a diagram illustrating an infrastructure management services architecture incorporating artificial intelligence for firmware development pipeline optimization.

FIG. 3 is a diagram illustrating a plugin creation interface of a FirmwareGPT platform.

FIG. 4(A) is a diagram illustrating a plugin marketplace interface displaying multiple specialized firmware plugins for selection and installation within a unified cloud platform.

FIG. 4(B) is a diagram illustrating how a user interacts with installed plugins in a chat-based environment.

FIG. 5 is a flowchart illustrating the detailed plugin creation workflow within the FirmwareGPT platform.

FIG. 6 is a diagram illustrating the model selection and training process within the plugin creation workflow.

FIG. 7 is a flowchart illustrating a chat interface workflow within the FirmwareGPT platform.

FIG. 8 is a diagram illustrating an example interaction between a user and a DTS File Plugin within the chat interface of the FirmwareGPT platform.

FIG. 9 is a flow chart of a method for creating and deploying plugins for firmware development.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

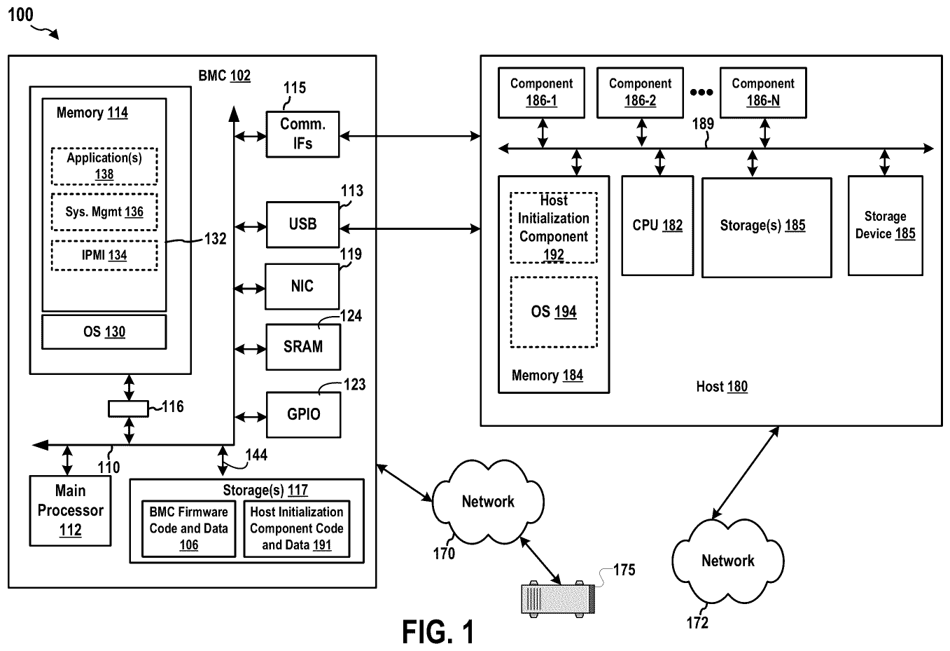

FIG. 1 is a diagram illustrating a computer system 100. In this example, the computer system includes, among other devices, a baseboard management controller (BMC) 102 and a host computer 180. The BMC 102 has, among other components, a main processor 112, a memory 114(e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123(i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

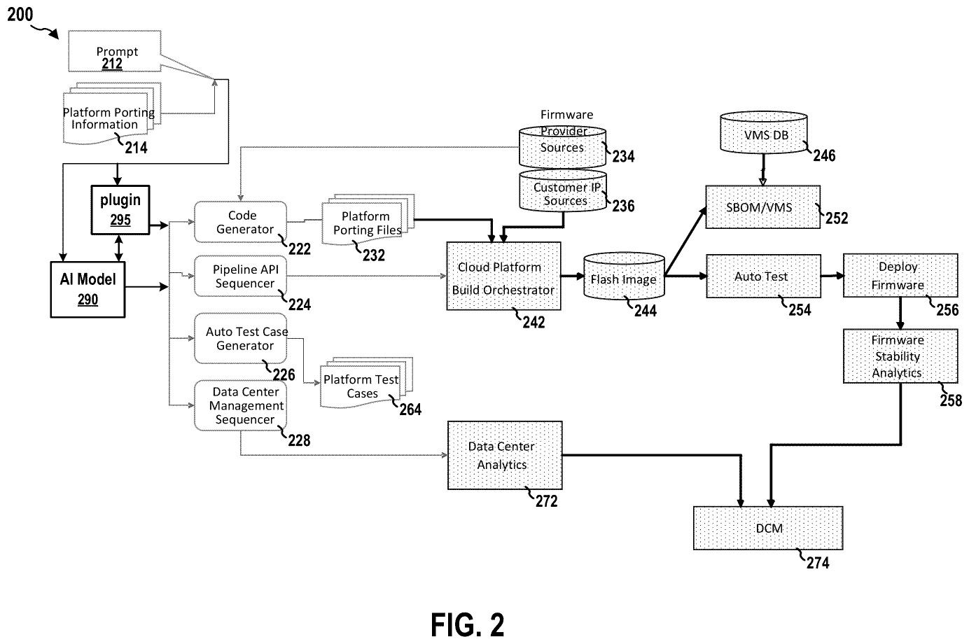

FIG. 2 is a diagram 200 illustrating an infrastructure management services architecture incorporating artificial intelligence for firmware development pipeline optimization. The diagram shows how the AI model 290 integrates with various components to create an intelligent firmware development and deployment workflow.

A prompt 212 and platform porting information 214 are first provided to an AI model 290, which interprets the request and interacts with a set of specialized modules that each perform different tasks in the pipeline. The AI model 290 communicates with a code generator 222, a pipeline API sequencer 224, an auto test case generator 226, and a data center management sequencer 228, forming an end-to-end orchestration system for creating, validating, and distributing firmware images.

The code generator 222 produces platform porting files 232 that reflect custom configurations and hardware requirements. These platform porting files 232 capture modifications needed for the target device, including platform-specific drivers, kernel-level definitions, and other configuration data. The pipeline API sequencer 224 coordinates with a cloud platform build orchestrator 242 to transform the platform porting files 232, along with firmware provider sources 234 and customer IP sources 236, into a compiled firmware image. This compiled product is stored as a flash image 244 that is subsequently passed through the remaining stages.

A VMS database 246 stores vulnerability information along with platform versions, which feeds into SBOM and VMS components 252 for creating a SBOM and vulnerability report for the constituent components and their versions. The system implements several validation and deployment stages, including an auto test procedure 254 and a firmware deployment procedure 256. A firmware stability analytics 258 component monitors the deployed firmware's performance and stability.

Once the flash image 244 is created, the auto test procedure 254 performs functional checks on the firmware to detect errors or inconsistencies. The VMS database 246 and the SBOM/VMS 252 work in conjunction to verify that the firmware image includes correct software components and that any dependencies are traceable. If the auto test procedure 254 completes without major issues, the firmware deployment procedure 256 is triggered, deploying the verified firmware to the intended systems. A firmware stability analytics 258 component monitors the deployed firmware in real time, identifying potential instabilities or bugs by collecting and analyzing system metrics and logs.

The auto test case generator 226 also supplies a set of platform test cases 264, which can be applied to the newly built firmware as part of the automated validation. Meanwhile, the data center management sequencer 228 gathers runtime feedback from the platform and combines it with information from the data center analytics 272 component. Insights from these analytics feed back into a DCM 274, closing the loop for performance tracking and platform health monitoring.

In this pipeline, each component communicates with the AI model 290 through a series of orchestrated API calls, allowing the prompt 212 to drive multiple tasks from code generation and image building to testing and deployment. The AI model 290 automatically interprets the context of the prompt, sequences the required microservices, and handles conditional tasks such as security checks, patch integrations, or performance evaluations. By integrating these steps into a single workflow, the cloud platform pipeline can dynamically generate and test firmware images based on high-level instructions, reducing manual overhead and bringing consistency to firmware development and delivery.

In the example of FIG. 2, the AI model 290 functions as an intelligent layer that interprets natural language prompts and coordinates multiple components to create an efficient firmware development workflow. The process begins when a user provides the prompt 212 and the platform porting information 214 to the AI model 290. The prompt 212 may include high-level instructions such as “Generate a BIOS image for my Intel platform and create a security report,” while the platform porting information 214 contains metadata and specific details about the target platform. The AI model 290 analyzes the prompt 212 and the platform porting information 214 to understand the user's intent and the specific requirements of the platform.

Upon interpreting the prompt, the AI model 290 interacts with several specialized modules to execute the required tasks. One of these modules is the code generator 222, which produces the platform porting files 232. The platform porting files 232 encapsulate custom configurations, platform-specific drivers, kernel settings, and other modifications necessary for the target device. By generating these files, the code generator 222 automates the creation of platform-specific artifacts that previously required manual intervention.

The pipeline API sequencer 224 acts as an intermediary between the AI model 290 and the cloud platform build orchestrator 242. The pipeline API sequencer 224 translates the analyzed intent from the prompt 212 into a sequence of API calls that invoke the appropriate microservices within the cloud platform build orchestrator 242. For instance, the pipeline API sequencer 224 may coordinate actions such as fetching source code from firmware provider sources 234 and customer IP sources 236, initiating the build process, running tests, and generating reports.

The cloud platform build orchestrator 242, in coordination with the pipeline API sequencer 224, compiles the firmware code using the platform porting files 232, firmware provider sources 234, and customer IP sources 236. The result is the flash image 244, which is a compiled firmware image ready for deployment.

To validate the generated firmware, the AI model 290 utilizes the auto test case generator 226. Based on the prompt 212, the platform porting information 214, and details of the target platform, the auto test case generator 226 produces the platform test cases 264. These test cases are designed to assess the specific features and configurations of the firmware for the target platform.

Once the flash image 244 is created, it undergoes testing through an auto test procedure 254. This procedure executes the platform test cases 264 to evaluate the firmware's functionality, performance, and stability. Test results, along with version management information from a VMS database 246 and software bill of materials from an SBOM/VMS component 252, are analyzed to determine the firmware's readiness for deployment.

After successful testing, the firmware deployment procedure 256 deploys the flash image 244 to the target systems. Post-deployment, the firmware stability analytics component 258 monitors the deployed firmware for any issues, collecting data on performance and reliability.

Furthermore, the AI model 290 interacts with a data center management sequencer 228. This module manages data center analytics 272 and communicates with a data center management (DCM) component 274. The data collected from deployed firmware installations is fed back into the system, enabling continuous improvement. Insights from the data center analytics 272 inform future firmware builds and configurations, supporting an iterative development process.

By integrating these components, the AI model 290 automates the firmware development pipeline. The AI model 290 interprets user prompts, generates necessary code and configurations, sequences API calls to orchestrate build and test processes, and manages deployment and analytics. This integration significantly reduces manual intervention, accelerates the development cycle, and enhances the consistency and quality of firmware releases.

Further, a plugin 295 is integrated with the system shown in FIG. 2. The plugin 295 is placed between a user and the AI model 290 to guide the user's request and to transform that request into data that is comprehensible to the pipeline components, including the code generator 222, the pipeline API sequencer 224, the auto test case generator 226, and the data center management sequencer 228. The plugin 295 also interacts with items such as the platform porting files 232, the firmware provider sources 234, the customer IP sources 236, and the cloud platform build orchestrator 242.

In one example, the plugin 295 provides an interface where a user uploads data (for instance, an image of an evaluation board or a device tree source file) and submits queries or instructions in natural language. The plugin 295 receives these instructions and directs them to the AI model 290 for analysis. This analysis produces commands and configuration data that can be delivered to the pipeline API sequencer 224, which coordinates tasks in the cloud platform build orchestrator 242. The plugin 295 may further manage responses generated by the AI model 290 to present refined feedback to the user, thereby allowing the user to confirm changes or to upload additional reference documents. The plugin 295 coordinates these interactions so that firmware tasks, such as updating device tree files or generating debug hints, can be carried out consistently.

The plugin 295 can be instantiated as a collection of microservices or application modules, each trained on specialized datasets that target different firmware tasks. For example, one microservice may be dedicated to parsing a device tree file, and another may be focused on generating test scenarios for a custom platform described in the platform porting information 214. After the AI model 290 processes the user's request, the plugin 295 receives the resulting instructions and may invoke the code generator 222 or the pipeline API sequencer 224 to produce compiled artifacts such as a flash image 244. The plugin 295 also interacts with the auto test case generator 226 to validate these artifacts and can present the resulting reports to the user. By integrating tightly with the auto test procedure 254 and the firmware deployment procedure 256, the plugin 295 extends the functionality of the pipeline to cover multiple tasks, including debugging, code porting, and image compilation.

In some embodiments, the plugin 295 operates by referencing platform porting files 232 or by retrieving other metadata from the VMS database 246 to handle version tracking. If user input includes images of hardware connections, the plugin 295 interprets them and converts them into a suitable query for the AI model 290. If the user's goal is to add new sensors to a baseboard management controller image, the plugin 295 can prompt the user for additional schematic information and feed that information to the pipeline API sequencer 224. The pipeline API sequencer 224 may then integrate these modifications with existing firmware provider sources 234 and customer IP sources 236 to generate the updated flash image 244. This image can be tested through the auto test procedure 254, verified by the firmware stability analytics 258, and eventually tracked by the data center analytics 272 and the DCM 274 for ongoing monitoring.

Through these interactions, the plugin 295 simplifies the user experience by masking the complexity of multiple pipeline components. It transforms specialized firmware operations into straightforward actions that can be performed by a chat-like or graphical interface. The plugin 295 may function as a mediator that accepts user requests, dispatches them to the AI model 290 for processing, and returns meaningful results to the user, enabling an end-to-end workflow for firmware development, configuration, testing, and deployment.

The plugin 295 implements a specialized architecture for managing firmware development tasks through artificial intelligence. This architecture addresses the challenge of transforming manual firmware development processes into automated workflows. The plugin 295 operates as an intermediary layer between users and the AI model 290, providing a structured approach for handling various firmware development scenarios, including platform porting, debugging, and configuration management.

The plugin 295 incorporates multiple specialized modules, each designed to handle specific firmware development tasks. For example, when converting from an evaluation board to a customer reference board, the plugin 295 coordinates with the code generator 222 to produce appropriate platform porting files 232. These files contain necessary modifications for hardware configurations, including changes in PCI slot configurations, memory support parameters, thermal specifications, and GPU support settings.

In operation, the plugin 295 receives natural language inputs through a chat-like interface and transforms these inputs into structured queries for the AI model 290. For instance, when a user needs to port sensor configurations from an evaluation board to a server platform, the plugin 295 collects relevant documentation, including schematics and datasheets, and coordinates with the pipeline API sequencer 224 to generate appropriate firmware code modifications.

The plugin 295 maintains continuous communication with the cloud platform build orchestrator 242, enabling seamless integration of generated code with existing firmware provider sources 234 and customer IP sources 236. This integration process includes automatic validation through the auto test procedure 254, which executes platform test cases 264 to verify the functionality of modified firmware components.

A significant feature of the plugin 295 is its ability to handle various input types. For image-based analysis, such as evaluation board setup verification, the plugin 295 processes uploaded images through specialized computer vision modules within the AI model 290. The results are then used to generate configuration suggestions or debugging recommendations. Similarly, for text-based inputs like device tree source files, the plugin 295 coordinates with the code generator 222 to produce updated configurations based on user requirements.

The plugin 295 also interfaces with the data center management sequencer 228 to incorporate runtime feedback from deployed firmware. This feedback loop enables the plugin 295 to refine its suggestions based on actual performance data collected through the firmware stability analytics 258 and data center analytics 272. The collected information is stored in the VMS database 246 and referenced during future firmware modifications.

Through this architecture, the plugin 295 transforms complex firmware development tasks into streamlined processes. For example, when porting firmware from a reference platform to a custom server configuration, the plugin 295 automatically identifies required modifications based on platform differences, generates appropriate code changes, and initiates validation procedures through the auto test procedure 254. This automation significantly reduces the manual effort traditionally required for such tasks.

The plugin 295 maintains version control integration through the SBOM/VMS 252, tracking all modifications and ensuring proper documentation of changes. This integration enables the plugin 295 to maintain a comprehensive history of firmware modifications and their associated validation results, supporting both development and compliance requirements.

This disclosure describes a system and method for creating, deploying, and utilizing artificial intelligence (AI) and machine learning (ML) based plugins within a unified cloud platform, specifically tailored for firmware development. The system facilitates the development of AI-driven plugins that automate and streamline various firmware-related tasks, such as platform porting, debugging, and configuration management. The architecture of the system is designed to be scalable and adaptable to various AI/ML use cases, including classification, design tree analysis, and image recognition. The platform provides a user interface for plugin creation, a backend workflow for plugin development and deployment, and a chat interface for interacting with the deployed plugins.

The plugin creation interface, as illustrated in the figures of this disclosure, allows users to define the basic parameters of a plugin, such as its name, description, and logo. Users can select an appropriate AI/ML model based on the specific use case. For example, for image recognition tasks, a user might choose a deep learning convolutional neural network (CNN), while for natural language processing tasks, models like OpenAI's GPT or Facebook's Llama might be selected. This selection process is made under a single platform, offering a variety of models to accommodate different types of firmware development tasks. The platform's design incorporates the capability to handle the different training approaches required for each model. Once the basic information is provided, users upload the training data in a format suitable for the chosen model. The platform guides this process, as the format requirements are integrated into the API endpoints associated with each model.

The backend workflow for plugin creation is defined to provide scalability and adaptability across different AI/ML models. When a user selects a model type through the interface, the platform's backend uses a predefined API endpoint to initiate the model training process. This process is tailored to the specific requirements of the chosen model, such as the format of the training data. The workflow manages the training process, and upon completion, stores the model output, which might be a file such as a model.pkl, in a designated location. This output is then tagged with the plugin name and the API endpoint, setting up an organized system for subsequent validation and deployment.

Validation of the plugin is performed through an API-based approach. When a user inputs data for validation, the platform directs this input to the tagged API endpoint, which returns a response generated by the trained model. This allows users to evaluate the model's accuracy and determine its suitability for deployment. If the user is satisfied with the model's performance, they can prepare the plugin for deployment, which includes adding documentation and submitting it for approval to be listed in the marketplace.

The chat interface provides a means for users to interact with the deployed plugins. After installing a plugin from the marketplace, users can select it within the chat interface and submit queries. The platform associates the submitted query with the selected plugin and routes it through an integration layer that includes a core AI engine. This engine directs the query to the API endpoint associated with the plugin. The plugin processes the query, potentially using input data uploaded by the user, and generates a response. This response is logged in a database for tracking purposes and is sent back to the core AI engine. The core AI engine may perform additional processing on the response, such as formatting it according to user instructions, before sending the final response back to the user interface.

The plugin 295, as shown in FIG. 2, serves as an interface between a user and the AI model 290. The plugin 295 guides a user's request and transforms that request into data that is comprehensible to pipeline components, including the code generator 222, the pipeline API sequencer 224, the auto test case generator 226, and the data center management sequencer 228. The plugin 295 also interacts with items such as the platform porting files 232, the firmware provider sources 234, the customer IP sources 236, and the cloud platform build orchestrator 242. The plugin 295 receives instructions and directs them to the AI model 290 for analysis. This analysis produces commands and configuration data that can be delivered to the pipeline API sequencer 224, which coordinates tasks in the cloud platform build orchestrator 242. The plugin 295 may further manage responses generated by the AI model 290 to present refined feedback to the user, thereby allowing the user to confirm changes or to upload additional reference documents.

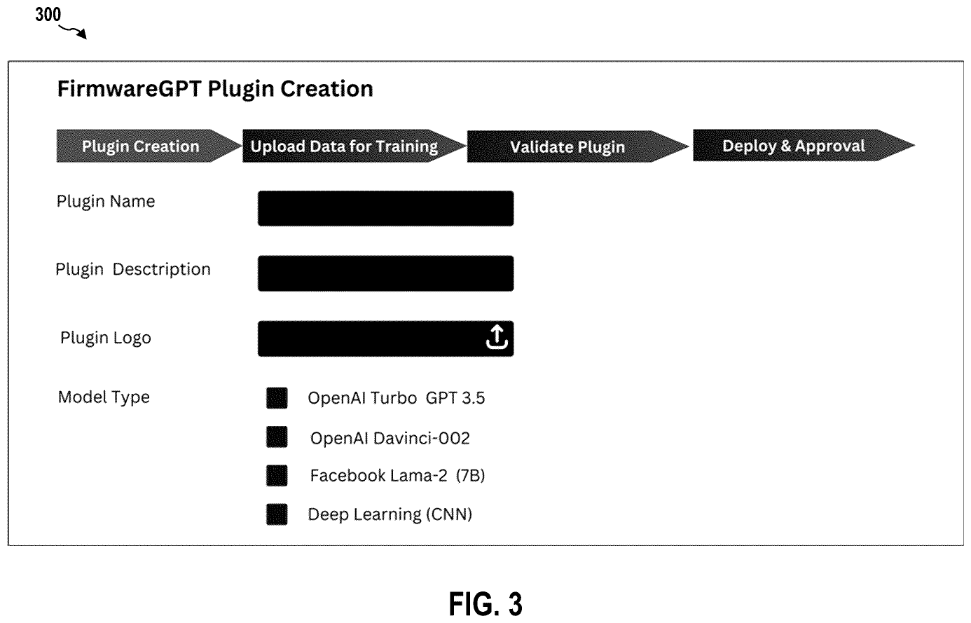

FIG. 3 is a diagram 300 illustrating a plugin creation interface of a FirmwareGPT platform. The diagram 300 shows a user interface designed to guide users through a process of creating, training, validating, and deploying AI-based plugins. The plugin creation interface includes a plurality of sections, including a plugin creation section, an upload data for training section, a validate plugin section, and a deploy and approval section.

In the plugin creation section, a user can input foundational details for a new plugin. For example, a user can enter a plugin name into a plugin name field, a plugin description into a plugin description field, and a plugin logo into a plugin logo field. These fields are used to establish the plugin's identity within the FirmwareGPT ecosystem. Further, a model type selection area allows the user to specify an AI/ML model that will power the plugin's functionality. Options for the AI/ML model include, for example, OpenAI Turbo GPT 3.5, OpenAI Davinci-002, Facebook Llama-2 (7B), and Deep Learning (CNN). The selection of the AI/ML model dictates the subsequent steps for training and data handling, as each model type has specific requirements.

The upload data for training section is used for uploading datasets necessary to train the selected AI/ML model. The format and structure of the training data are dependent on the model type chosen in the previous step. For instance, if a user selects OpenAI's models, the platform will expect the data to be in a JSONL format, comprising prompt and completion pairs. The interface adapts to these requirements, using the API endpoint associated with each model to guide the user in providing data in a proper format.

After uploading the training data, the user can proceed to the validate plugin section. This section enables the user to test the performance of the trained model by inputting sample data and receiving responses generated by the plugin. For example, in the case of an image recognition model, the user might upload a test image. The platform then routes this input through the designated API endpoint, and the trained model processes the input to produce an output. This output is presented to the user, allowing them to assess the model's accuracy and determine if further adjustments are needed.

The final section, deploy and approval, facilitates the deployment of the validated plugin. Once a user is satisfied with the plugin's performance, they can submit the plugin for review and approval. Upon approval, the plugin is listed in a marketplace, making it available for other users to install and use. This section also includes an option for adding documentation, providing detailed information about the plugin's functionality and usage.

The plugin creation interface is integrated with a backend workflow that manages the plugin development and deployment process. When a user selects a model type, the platform's backend initiates a training process tailored to the chosen model's requirements. The training output, which may be a model file such as model.pkl, is stored in a specific location and tagged with the plugin name and API endpoint. This organization supports the validation and subsequent deployment of the plugin. The backend workflow is designed to be scalable and adaptable, accommodating different AI/ML models and use cases.

The chat interface, as part of the FirmwareGPT platform, allows users to interact with deployed plugins. After installing a plugin from the marketplace, users can select it in the chat interface and submit queries. The platform associates the query with the selected plugin and routes it through an integration layer involving a core AI engine 290. The core AI engine 290 directs the query to the API endpoint associated with the plugin 295. The plugin 295 processes the query, potentially using input data uploaded by the user, and generates a response. This response is logged in the VMS database 246 for tracking and sent back to the core AI engine 290. The core AI engine 290 may perform additional processing on the response, such as formatting it according to user instructions, before sending the final response to the user interface. The plugin 295, shown in FIG. 2, acts as an interface between a user and the AI model 290, guiding user requests and transforming them into data comprehensible to pipeline components. These components include the code generator 222, the pipeline API sequencer 224, the auto test case generator 226, and the data center management sequencer 228.

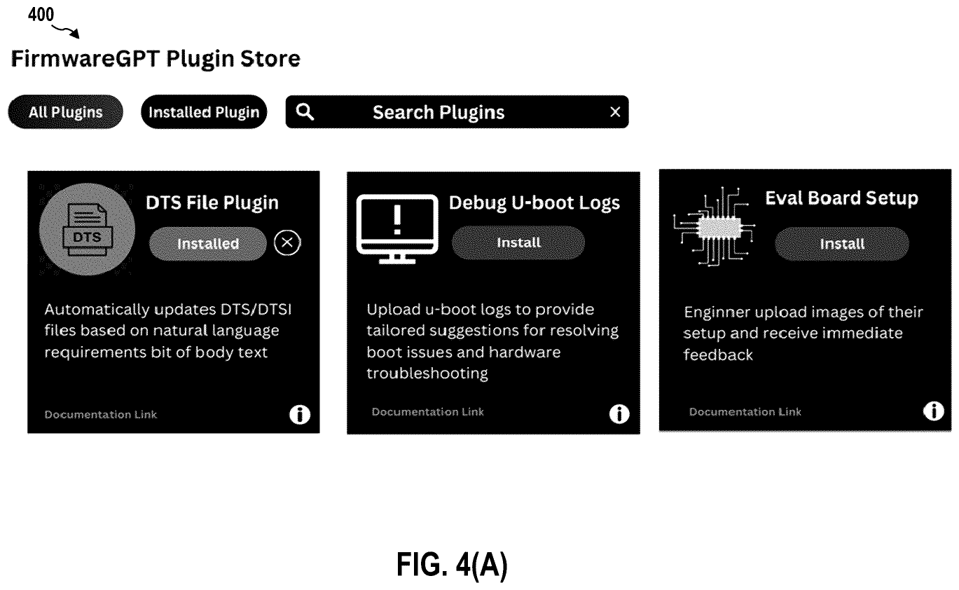

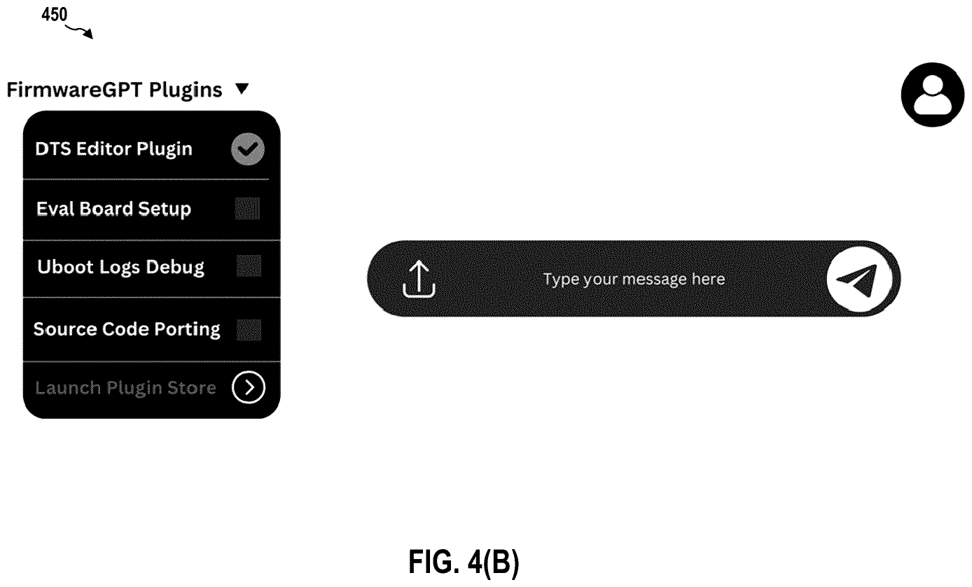

FIG. 4(A) is a diagram 400 illustrating a plugin marketplace interface in which multiple specialized firmware plugins are displayed for selection and installation within a unified cloud platform. A search bar provides a means for users to locate a desired plugin by name or function, and each plugin card presents both a descriptive label and a corresponding action button that allows users to install or remove the plugin. For example, one plugin card shows a DTS File Plugin that helps a user modify device tree source files, while another offers a U-Boot log debugging plugin for analyzing error messages or hardware failures. These plugins can implement the plugin 295 that functions as an intermediary between a user's natural language query and the AI model 290. The plugin 295 can direct firmware-related requests to various pipeline components, including the code generator 222 and the pipeline API sequencer 224, where data is prepared and transformed into actionable output, such as device tree modifications or platform-specific debugging hints. In FIG. 4(A), the marketplace also provides an option to view installed plugins. Users can manage active plugins that integrate with the auto test case generator 226 and the data center management sequencer 228 to create a continuous feedback loop of firmware development, testing, and analytics.

FIG. 4(B) is a diagram 450 illustrating how a user, after installing or activating one or more plugins, may interact with them in a chat-based environment. A selection panel lists available plugins, such as a DTS editor plugin or a U-Boot logs debug plugin, which can be toggled on or off according to the user's task. When a plugin is selected, any text, files, or images that the user uploads become the input for that plugin's specialized processing. For instance, if the user has installed a plugin for managing device tree entries, the chat interface allows the user to provide a DTS file and request specific modifications, such as enabling advanced bus functionalities for a given platform. The plugin 295 sends this request to the AI model 290, which can consult the platform porting files 232 or the firmware provider sources 234 through the pipeline API sequencer 224 in order to generate the changes needed. Once processed, the chat interface displays the result, which may be a revised device tree or a summary of configuration edits. This chat-based mechanism, shown in FIG. 4(B), highlights a platform approach for addressing diverse firmware requirements, from debugging boot logs to creating updated kernel images and even integrating new functionality derived from the data center analytics 272 or monitored through firmware stability analytics 258.

By selecting and activating different plugins, users can perform tasks such as debugging boot failures, editing device tree files, verifying physical board setups through image analysis, and generating porting code to meet new hardware requirements. This system may address the problems of long development cycles and heavy reliance on manual intervention by providing a centralized environment. This environment may allow convenient selection of plugins that tap into the AI model 290 for text and image processing, as well as may orchestrate interactions with underlying firmware build systems, such as the cloud platform build orchestrator 242, thus reducing the time and effort associated with tasks like source code porting or hardware-based debugging. The ability to manage plugins from a single marketplace and to interface with them through an interactive chat provides a streamlined workflow that integrates with the auto test procedure 254 for validation and the firmware deployment procedure 256 for distribution.

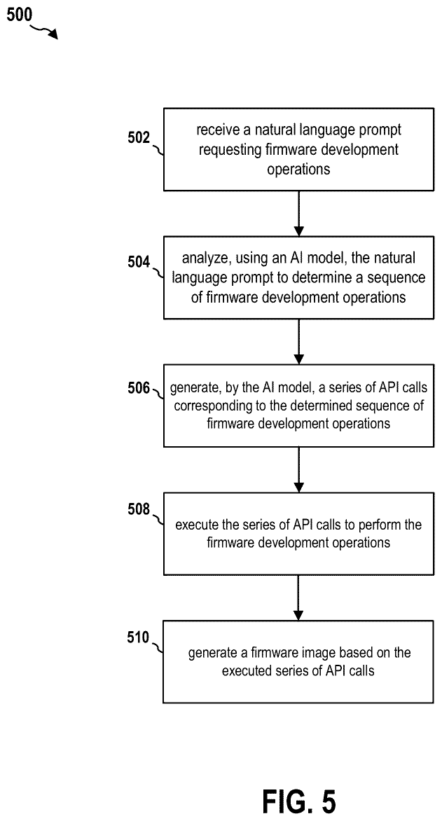

FIG. 5 is a flowchart 500 illustrating the detailed plugin creation workflow within the FirmwareGPT platform, which is hosted as part of a cloud platform service. This workflow outlines the backend processes that enable users to create, train, validate, and deploy AI-based plugins tailored for firmware development tasks.

In operation 502, the FirmwareGPT platform is hosted in the cloud as part of the cloud platform service, providing a centralized and accessible environment for plugin development. In operation 504, users begin by logging into the platform and accessing the plugin creation service, which offers an intuitive interface designed to guide them through the plugin creation process.

In operation 506, the interface collects all required data from the user to create the plugin. This includes essential details such as the plugin name, a description outlining its functionality, and a logo for identification within the platform. The user selects the model type appropriate for their specific use case. This selection could range from text-based models for natural language processing tasks to image recognition models for analyzing visual data. The platform accommodates various AI models, including OpenAI's GPT series, Facebook's Llama, and traditional machine learning and deep learning models.

Once the user provides the necessary information, the platform proceeds to operation 508. Based on the input provided and the type of model chosen, a specific API endpoint is invoked to initiate the model training process. The platform integrates these diverse AI models through a unified set of APIs, effectively abstracting the complexities associated with each model's training requirements. This integration allows the platform to handle the unique data formats and training procedures required by different models seamlessly.

In operation 510, upon completion of the model training process, the model output is stored in a designated path within the platform's storage system. This output is typically a trained model file, such as a ‘model.pkl’ file for Python-based models, which contains the learned parameters necessary for the plugin to perform its tasks. The model is tagged to a specific API endpoint associated with the plugin name, establishing a clear linkage between the trained model and the plugin's interface.

Operation 512 involves storing the model path and the API endpoint information in the platform's database. For instance, a plugin named “dts_file_model_1.0” might have its model stored at a path like ‘cloudplatform/dts_file_model_1.0/model.pkl’, and be accessible via an API endpoint such as ‘/cloudplatform/registry/api/v1/dtsfile’. This organized storage and tagging facilitate efficient retrieval and execution of the model during plugin operations, supporting scalability and maintainability.

After the model is trained and stored, in operation 514, focusing on testing and quality assurance, the platform provides tools for verifying the plugin's functionality and performance by accessing the API endpoint and evaluating the model's responses to test inputs. In operation 516, the plugin is packaged with essential documentation, including usage instructions, capabilities, and any necessary guidance.

Finally, in operation 518, the plugin undergoes an approval and review process before being displayed in the plugin marketplace. Platform administrators or reviewers determines whether the plugin adheres to platform standards. Upon approval, the plugin becomes available in the marketplace, allowing other users to discover, install, and benefit from its functionalities.

This workflow embodies a modular design, where plugins are developed as independent modules that can be integrated into the FirmwareGPT platform. It facilitates collaboration across different departments within the firmware provider organization by providing a flexible and horizontal architecture. This approach encourages diverse contributions and aligns with the organization's perspective on cross-departmental collaboration to drive AI-related developments.

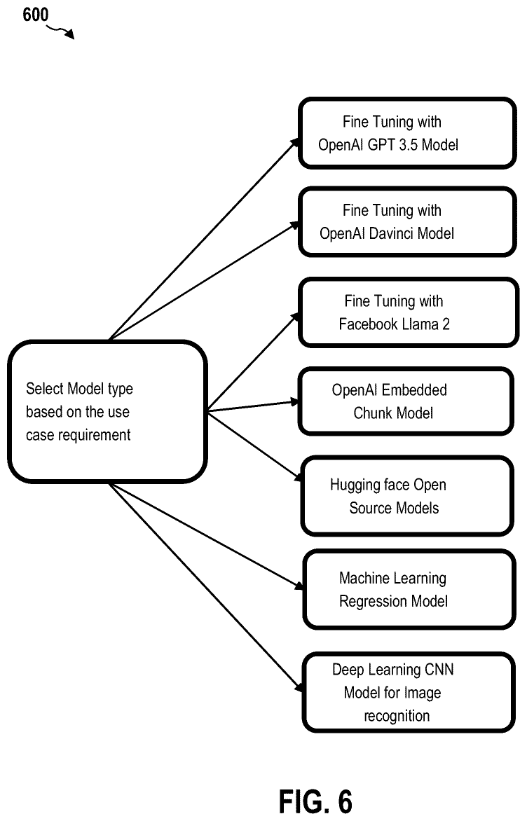

FIG. 6 is a diagram 600 illustrating the model selection and training process within the plugin creation workflow. This diagram emphasizes how users select an AI model based on their specific use case requirements and how the platform accommodates this selection through tailored training processes.

The process begins with the user selecting the model type suitable for their use case. The platform offers a range of model options, including fine-tuning with OpenAI GPT-3.5, fine-tuning with OpenAI Davinci models, fine-tuning with Facebook Llama 2, utilizing OpenAI's embedded chunk models, using Hugging Face's open-source models, employing machine learning regression models, and deploying deep learning convolutional neural networks (CNNs) for image recognition tasks.

For models like OpenAI's GPT-3.5 and Davinci, once the user selects the model, the platform guides them to follow OpenAI's fine-tuning procedures with their custom dataset. This involves formatting the training data according to OpenAI's specifications, typically requiring a JSON Lines (‘.jsonl’) format with prompt-completion pairs. The platform's integration ensures that users can seamlessly upload their data and initiate the fine-tuning process through the associated API endpoints.

When users opt for Facebook Llama 2, the platform provides guidance based on Facebook's fine-tuning procedures. Similar to OpenAI's models, the user uploads their dataset in the required format, and the platform handles the interaction with the model's API to start the training process.

For the OpenAI embedded chunk model, the platform employs an approach that involves chunking input data and converting it into vector embeddings. This method is effective for tasks that involve handling large documents or datasets by breaking them into smaller, manageable pieces and capturing their semantic meaning.

When utilizing Hugging Face's open-source models, the platform encourages users to select a model that aligns with their task and provides a description of the fine-tuning process. The platform integrates with Hugging Face's library, enabling users to customize models with their datasets and deploy them via the platform's APIs.

For traditional machine learning regression models and deep learning models like CNNs, the platform outlines a general approach:
1. Collect and Prepare Datasets: Users gather and preprocess the data relevant to their task, ensuring it is clean and suitable for modeling.
2. Exploratory Data Analysis (EDA): Users perform EDA to understand patterns, trends, and relationships within the data. This step is for identifying significant features and gaining insights that inform model selection.
3. Feature Engineering and Selection: Users select relevant variables and engineer new features that enhance the model's predictive capabilities.
4. Model Selection: Based on the task, users choose an appropriate regression model, such as linear regression or decision trees, or a deep learning architecture like CNNs or recurrent neural networks (RNNs).
5. Data Splitting: Users divide the data into training and testing sets, typically using a 70-30 or 80-20 split, to evaluate the model's performance on unseen data.
6. Model Training: Users train the model using Python frameworks like Scikit-learn for machine learning models or TensorFlow and PyTorch for deep learning models. The platform facilitates this process by integrating these frameworks and providing computational resources. 7. Evaluation and Deployment: Users evaluate the model's performance using appropriate metrics and, upon satisfaction, deploy the model via API endpoints accessible within the plugin.

The plugin creation and model selection processes are integrated with the platform's backend components, including the AI model 290, the code generator 222, the pipeline API sequencer 224, and others as illustrated in FIG. 2. The platform's architecture supports this integration through generic APIs and a unified data management system. When a user initiates model training, the platform invokes the appropriate API endpoint based on the selected model type. It handles data formatting, model-specific training procedures, and stores the resulting trained model in a structured manner. The model path and API endpoint are stored in the database.

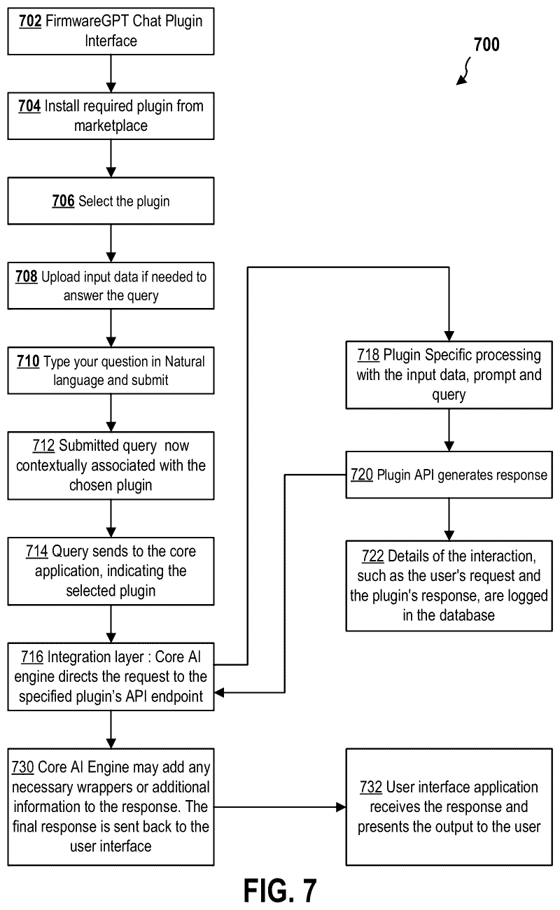

FIG. 7 is a flowchart 700 of a chat interface workflow within the FirmwareGPT platform, illustrating how a user interacts with the system to utilize AI-based plugins for firmware development tasks. In operation 702, the user accesses the FirmwareGPT chat plugin interface. This interface provides a unified environment where users can communicate with various plugins installed on the platform. The user begins by installing the required plugin from the marketplace in operation 704. The marketplace, as previously described in FIG. 4(A), offers a selection of plugins tailored for different firmware-related use cases.

Once the desired plugin is installed, the user selects the plugin in operation 706. The selection of the plugin is significant because it contextually associates subsequent user queries with the capabilities and functionalities of the chosen plugin. In operation 708, the user may upload input data necessary for the plugin to process the query effectively. This input data could be, for example, a device tree source (DTS) file, schematic documents, or any relevant files that the plugin might require to generate an accurate response.

Following the upload of input data, the user proceeds to operation 710, where they type their question or command in natural language and submit it through the chat interface. This natural language query, combined with any uploaded input data, forms the basis of the interaction with the plugin.

In operation 712, the system contextually associates the submitted query with the selected plugin. This association directs the subsequent processing stages to utilize the appropriate resources and models related to the plugin's specific functionalities.

The query is then sent to the core application in operation 714, indicating the selected plugin. The core application includes an integration layer that consists of the core AI engine 290, as illustrated in FIG. 2. In operation 716, the core AI engine 290 directs the request to the specified plugin's API endpoint. This redirection is facilitated by the tagging of the plugin with its corresponding API endpoint during the plugin creation process, as described in FIG. 5.

Upon receiving the request, the plugin engages in specific processing in operation 718. This processing involves utilizing the input data, the user's prompt, and the query to generate an appropriate response. The plugin may interact with various components, such as the code generator 222, the pipeline API sequencer 224, and potentially access platform porting files 232 or firmware provider sources 234, depending on the nature of the query and the plugin's functionality.

In operation 720, the plugin's API generates a response based on the processing performed. This response may include modified code snippets, configuration files, debugging suggestions, or any output relevant to the user's request. The details of the interaction, including the user's request and the plugin's response, are logged in the VMS database 246 in operation 722. This logging facilitates tracking, analytics, and potential future enhancements of the system.

The response generated by the plugin is sent back to the core AI engine 290. In operation 730, the core AI engine 290 may add any necessary wrappers or additional information to the response. This step might involve formatting the output according to user preferences, converting data into specific formats like bullet points, HTML, or JSON, or integrating additional context that enhances the usability of the response.

Finally, in operation 732, the user interface application receives the response and presents the output to the user. The user interface displays the response in the chat interface, allowing the user to review the results of their query. The components involved in this workflow, including the core AI engine 290, the plugin 295, and the various backend processing modules, collaborate to interpret user intents and execute the necessary operations.

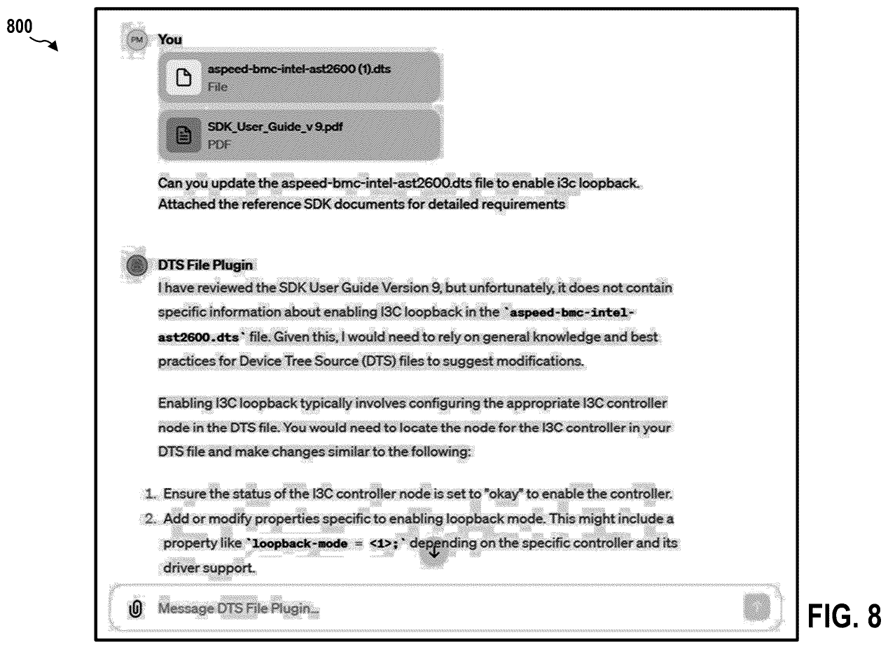

FIG. 8 is a diagram 800 illustrating an example interaction between a user and a DTS File Plugin within the chat interface of the FirmwareGPT platform. The diagram shows how the plugin processes natural language requests to modify device tree source (DTS) files with appropriate configurations.

At a chat interface, the user has uploaded two files-a DTS file named “aspeed-bmc-intel-ast2600.dts” and a reference document “SDK_User_Guide_v9.pdf”. The user submits a natural language request asking to update the DTS file to enable I3C loopback functionality, referencing the SDK documentation for detailed requirements.

As described supra, the plugin 295 serves as an intermediary between user requests and the AI model 290's processing capabilities. The DTS File Plugin responds with a detailed analysis and suggested modifications. The plugin first acknowledges reviewing the SDK User Guide Version 9, noting that while specific I3C loopback information is not directly contained in the documentation, it can rely on general knowledge and best practices for Device Tree Source modifications. The plugin then provides structured guidance for modifying the DTS file, explaining that enabling I3C loopback typically requires configuring the appropriate I3C controller node. The response outlines two key modifications: setting the status of the I3C controller node to “okay” to enable the controller, and adding or modifying properties specific to enabling loopback mode, such as including a property like “loopback-mode=<1>” depending on the specific controller and driver support requirements.

The plugin integrates with the code generator 222 and the pipeline API sequencer 224 to analyze the input files and generate appropriate configuration suggestions. The plugin can process both the technical requirements embedded in the DTS file and the contextual information provided in the SDK documentation, delivering a response that bridges the gap between natural language requests and technical firmware modifications.

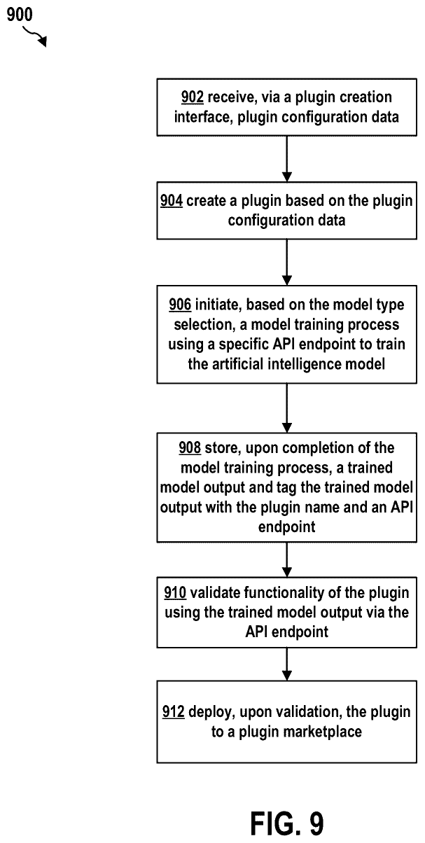

FIG. 9 is a flow chart 900 of a method for creating and deploying plugins for firmware development. The method may be performed by one or more computing devices (e.g., devices of the cloud platform described in FIG. 2). In operation 902, the one or more computing devices receive, via a plugin creation interface, plugin configuration data comprising a plugin name, a plugin description, and a model type selection. In operation 904, the one or more computing devices create a plugin based on the plugin configuration data, wherein the plugin serves as an interface between a user and an artificial intelligence model. In operation 906, the one or more computing devices initiate, based on the model type selection, a model training process using a specific application programming interface (API) endpoint to train the artificial intelligence model. In operation 908, the one or more computing devices store, upon completion of the model training process, a trained model output and tag the trained model output with the plugin name and an API endpoint. In operation 910, the one or more computing devices validate functionality of the plugin using the trained model output via the API endpoint. In operation 912, the one or more computing devices deploy, upon validation, the plugin to a plugin marketplace.

In certain configurations, the model type selection comprises at least one of: a large language model (LLM), a deep learning convolutional neural network (CNN) model, or a machine learning regression model. To train the model, the one or more computing devices receive training data formatted according to requirements specific to the selected model type, and process the training data using model-specific training procedures determined by the model type selection.

In certain configurations, the one or more computing devices receive, via a chat interface, a user query and input data. The one or more computing devices select a deployed plugin from the plugin marketplace. The one or more computing devices route the user query and input data to the API endpoint associated with the selected deployed plugin. The one or more computing devices generate a response using the trained model output associated with the selected deployed plugin. The one or more computing devices present the response via the chat interface.

In certain configurations, the one or more computing devices process, by a core AI engine, the response from the selected deployed plugin, add formatting information to the response based on user preferences, and transmit the formatted response to the chat interface. To route the user query, the one or more computing devices contextually associate the user query with the selected deployed plugin, transmit the contextually associated query to a core application, and direct, by an integration layer, the query to the API endpoint associated with the selected deployed plugin.

In certain configurations, the input data comprises at least one of: a device tree source (DTS) file, a firmware log file, an image of a hardware setup, or a schematic document. In certain configurations, the one or more computing devices log interaction details comprising the user query and the response in a database, and track plugin usage analytics based on the logged interaction details. In certain configurations, the one or more computing devices receive documentation for the plugin, and submit the plugin with the documentation for an approval process prior to deployment in the plugin marketplace.

To perform the model training process, the one or more computing devices perform exploratory data analysis on training data, select relevant features for model training, divide the training data into training and testing sets, and evaluate model accuracy using the testing set.

In certain configurations, the one or more computing devices integrate the plugin with a firmware development pipeline comprising: a code generator, a pipeline API sequencer, an auto test case generator, and a data center management sequencer. To integrate the plugin, the one or more computing devices receive firmware modification requirements via the plugin, generate modified firmware code using the code generator, validate the modified firmware code using the auto test case generator, and deploy the validated firmware code using the pipeline API sequencer. To validate functionality, the one or more computing devices receive test input data via the plugin creation interface, process the test input data using the trained model output, generate test results, and determine whether the test results meet predetermined accuracy thresholds.

In certain configurations, the one or more computing devices store the trained model output in a designated path within a cloud platform, and maintain a database record linking the plugin name, the designated path, and the API endpoint. In certain configurations, the plugin creation interface is hosted on a cloud platform, and the one or more computing devices provide access to the plugin creation interface through user authentication, and manage plugin deployment and marketplace listing through the cloud platform.

The computing devices and components described in FIGS. 2-9 may be implemented by the computer system 100 shown in FIG. 1. For example, the host computer 180, which includes the host CPU 182, host memory 184, and storage device(s) 185, may execute instructions to implement the FirmwareGPT platform, including the plugin creation interface, marketplace interface, and chat interface shown in FIGS. 3-4. The host computer 180 may also implement the AI model 290, code generator 222, pipeline API sequencer 224, auto test case generator 226, and other components shown in FIG. 2. The storage device(s) 185 may store the model outputs, API endpoints, and other data used by the plugins, while the host memory 184 may store instructions for executing the workflows shown in FIGS. 5-7 and the method shown in FIG. 9. The BMC 102 may provide management and monitoring capabilities that complement the firmware development functions implemented by the host computer 180.

The host computer 180 may communicate with other systems through the data network 172 to access cloud services and resources needed for the FirmwareGPT platform. For example, when implementing the plugin creation workflow of FIG. 5, the host computer 180 may interact with cloud-based AI/ML training services through the data network 172. Similarly, when implementing the chat interface workflow of FIG. 7, the host computer 180 may communicate with cloud-based API endpoints and model serving infrastructure. The BMC 102 may monitor the host computer 180's performance and health while it executes these firmware development workloads.

It is understood that the specific order or hierarchy of blocks in the processes / flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
receiving, via a plugin creation interface, plugin configuration data comprising a plugin name, a plugin description, and a model type selection;
creating a plugin based on the plugin configuration data, wherein the plugin serves as an interface between a user and an artificial intelligence model;
initiating, based on the model type selection, a model training process using a specific application programming interface (API) endpoint to train the artificial intelligence model;
storing, upon completion of the model training process, a trained model output and tagging the trained model output with the plugin name and an API endpoint;
validating functionality of the plugin using the trained model output via the API endpoint; and
deploying, upon validation, the plugin to a plugin marketplace.

2. The method of claim 1, wherein the model type selection comprises at least one of:
a large language model (LLM);
a deep learning convolutional neural network (CNN) model; or
a machine learning regression model.

3. The method of claim 1, further comprising:
receiving training data formatted according to requirements specific to the selected model type; and
processing the training data using model-specific training procedures determined by the model type selection.

4. The method of claim 1, further comprising:
receiving, via a chat interface, a user query and input data;
selecting a deployed plugin from the plugin marketplace;
routing the user query and input data to the API endpoint associated with the selected deployed plugin;
generating a response using the trained model output associated with the selected deployed plugin; and
presenting the response via the chat interface.

5. The method of claim 4, further comprising:
processing, by a core AI engine, the response from the selected deployed plugin;
adding, by the core AI engine, formatting information to the response based on user preferences; and
transmitting the formatted response to the chat interface.

6. The method of claim 4, wherein routing the user query comprises:
contextually associating the user query with the selected deployed plugin;
transmitting the contextually associated query to a core application; and
directing, by an integration layer, the query to the API endpoint associated with the selected deployed plugin.

7. The method of claim 4, wherein the input data comprises at least one of:
a device tree source (DTS) file;
a firmware log file;
an image of a hardware setup; or
a schematic document.

8. The method of claim 4, further comprising:
logging interaction details comprising the user query and the response in a database; and
tracking plugin usage analytics based on the logged interaction details.

9. The method of claim 1, further comprising:
receiving documentation for the plugin; and
submitting the plugin with the documentation for an approval process prior to deployment in the plugin marketplace.

10. The method of claim 1, wherein the model training process comprises:
performing exploratory data analysis on training data;
selecting relevant features for model training;
dividing the training data into training and testing sets; and
evaluating model accuracy using the testing set.

11. The method of claim 1, further comprising:
integrating the plugin with a firmware development pipeline comprising:
a code generator;
a pipeline API sequencer;
an auto test case generator; and
a data center management sequencer.

12. The method of claim 11, wherein integrating the plugin comprises:
receiving firmware modification requirements via the plugin;
generating modified firmware code using the code generator;
validating the modified firmware code using the auto test case generator; and
deploying the validated firmware code using the pipeline API sequencer.

13. The method of claim 1, wherein validating functionality comprises:
receiving test input data via the plugin creation interface;
processing the test input data using the trained model output;
generating test results; and
determining whether the test results meet predetermined accuracy thresholds.

14. The method of claim 1, further comprising:
storing the trained model output in a designated path within a cloud platform; and
maintaining a database record linking the plugin name, the designated path, and the API endpoint.

15. The method of claim 1, wherein the plugin creation interface is hosted on a cloud platform, and wherein the method further comprises:
providing access to the plugin creation interface through user authentication; and
managing plugin deployment and marketplace listing through the cloud platform.

16. A system, including one or more computing devices, comprising:
a memory; and
at least one processor coupled to the memory and configured to:
receive, via a plugin creation interface, plugin configuration data comprising a plugin name, a plugin description, and a model type selection;
create a plugin based on the plugin configuration data, wherein the plugin serves as an interface between a user and an artificial intelligence model;
initiate, based on the model type selection, a model training process using a specific application programming interface (API) endpoint to train the artificial intelligence model;
store, upon completion of the model training process, a trained model output and tag the trained model output with the plugin name and an API endpoint;
validate functionality of the plugin using the trained model output via the API endpoint; and
deploy, upon validation, the plugin to a plugin marketplace.

17. The system of claim 16, wherein the model type selection comprises at least one of:
a large language model (LLM);
a deep learning convolutional neural network (CNN) model; or
a machine learning regression model.

18. The system of claim 16, wherein the at least one processor is further configured to:
receive training data formatted according to requirements specific to the selected model type; and
process the training data using model-specific training procedures determined by the model type selection.

19. The system of claim 16, wherein the at least one processor is further configured to:
receive, via a chat interface, a user query and input data;
select a deployed plugin from the plugin marketplace;
route the user query and input data to the API endpoint associated with the selected deployed plugin;
generate a response using the trained model output associated with the selected deployed plugin; and
present the response via the chat interface.

20. A non-transitory computer-readable medium storing computer executable code for operating one or more computing devices, comprising code to:
receive, via a plugin creation interface, plugin configuration data comprising a plugin name, a plugin description, and a model type selection;
create a plugin based on the plugin configuration data, wherein the plugin serves as an interface between a user and an artificial intelligence model;
initiate, based on the model type selection, a model training process using a specific application programming interface (API) endpoint to train the artificial intelligence model;
store, upon completion of the model training process, a trained model output and tag the trained model output with the plugin name and an API endpoint;
validate functionality of the plugin using the trained model output via the API endpoint; and
deploy, upon validation, the plugin to a plugin marketplace.
